(19) United States
(12) Patent Application Publication
(10) Pub. No.: US 2008/0314926 A1
(43) Pub. Date: Dec. 25, 2008

(54) MODULAR BEVERAGE DISPENSING SYSTEM AND METHOD

(75) Inventors: Sanjay Kumar, Ridgefield, CT (US); Scott Dzibela, Carmel, NY (US); Fernando Ubidia, Ludlow, MA (US); John Lewis, Monson, MA (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 11/765,770

(22) Filed: Jun. 20, 2007

(51) Int. Cl. B67D 5/56

(52) U.S. Cl. 222/129.1

(57) ABSTRACT

A mobile beverage dispensing unit includes a replaceable syrup module, a replaceable liquid module, and a replaceable mixing module. The replaceable mixing module creates a beverage by mixing liquid that is dispensed from the replaceable liquid module and syrup that is contained in the replaceable syrup module to create a beverage. The mobile beverage dispensing unit may contain a replaceable dispensing module that dispenses the beverage that is formed in the replaceable mixing module. A plumbing module may connect the replaceable liquid module and the replaceable syrup module to the replaceable mixing module and may also connect the replaceable mixing module to the replaceable dispensing unit. A user may cause the beverage to be dispensed from the replaceable dispensing module by operating a dispensing mechanism that controls the flow of the beverage.

### FIELD OF THE INVENTION

This invention relates generally to beverage dispensing systems. More particularly, aspects of the invention provide modular beverage dispensing systems and methods for dispensing beverages with a modular beverage dispensing system.

### BACKGROUND OF THE INVENTION

Beverage dispensing units have become a popular way for food and beverage establishments to create on-site fountain beverages. Typically, these units include several bag-in-box containers that each contains syrup, a liquid source that dispenses a liquid, a mixing unit, and a dispensing unit. Syrup is pumped from the bag-in-box container into the mixing unit where it is mixed with liquid to form a beverage that is then dispensed through the dispensing unit. Typically, a pump causes the syrup to be released from the bag-in-box container into the mixing unit.

Conventional beverage dispensing units and systems position the bag-in-box containers and the pump in a back room, such as a storage room or food preparation area, because they can be noisy and can be distracting to patrons. The dispensing unit is oftentimes positioned in the foodservice area of the restaurant or bar so that staff and/or patrons may have access to it. This unit is time-consuming to assemble, disassemble, and service because it is positioned in multiple rooms and because portions of the unit are difficult to access. Assembly, disassembly, and service of this beverage dispensing unit are oftentimes performed by a highly skilled technician due to the complex nature of the unit.

Sellers incur high costs to install and initially service beverage dispensing units. Frequently, a beverage dispensing unit is moved from one premise to another or removed altogether after a short period of time, which causes the seller to lose money on the initial installation and service. Moreover, some food and beverage establishments may wish to transport the beverage dispensing unit to an outdoor location or another indoor location. Therefore, a beverage dispensing unit is needed that is mobile and modular, that operates at a low noise level, and that reduces the amount of time and the level of skill required to assemble, disassemble, and service the unit.

### BRIEF SUMMARY OF THE INVENTION

Aspects of the invention overcome problems and limitations of the prior art by providing a mobile beverage dispensing unit, a mobile beverage dispensing system, and a method of providing a fountain beverage, each comprising modules that may be easily assembled, disassembled, and serviced.

In one embodiment of a mobile beverage dispensing unit, a plurality of modules are connected to each other and are capable of creating a beverage that may be dispensed. The unit may include a replaceable syrup module, a replaceable liquid module, a replaceable mixing module, and a plumbing module. The replaceable syrup module may contain syrup and the replaceable liquid module may be capable of dispensing a liquid. The syrup and the liquid may be released from the replaceable syrup module and the replaceable liquid module, respectively. The syrup and the liquid may be mixed together in the replaceable mixing module to form a beverage that may be dispensed by a replaceable dispensing module. A first portion of the plumbing module may connect the replaceable syrup module and the replaceable liquid module to the replaceable mixing module and a second portion of the plumbing module may connect the replaceable mixing module to the replaceable dispensing module. The plumbing module may be a hose that is capable of containing the syrup, the liquid, and the beverage as each flows between modules. Each module of the mobile beverage dispensing unit may be positioned within the same room.

In an embodiment of the mobile beverage dispensing unit, the liquid is water or carbonated water and it may be mixed with the syrup to create a beverage. The replaceable syrup module may be a bag-in-box container. A pump may cause the syrup that is contained within the bag-in-box container to be released into the plumbing module and flow into the replaceable mixing module. The mobile beverage dispensing unit may include a plurality of replaceable syrup modules that each contains a different flavored syrup that may be mixed with the liquid to create a variety of flavored beverages. The liquid or beverage may be carbonated or filtered before the beverage is dispensed. A mobile beverage dispensing unit may also include a pan that is positioned to collect syrup and liquid that may leak from the mobile beverage dispensing unit when it is in operation. The mobile beverage dispensing unit may also include a tray that supports the replaceable syrup module. A portion of the tray may be stainless steel and the edges of the tray may be smooth.

In an additional embodiment of the invention, a method may be practiced of providing an on-site fountain-quality beverage that comprises mixing together syrup that is pumped from a replaceable syrup module and liquid that is dispensed from a replaceable liquid module to form a beverage that is then dispensed. Each of the replaceable syrup module, the replaceable liquid module, and the replaceable mixing module may be positioned within the same room.

### BRIEF DESCRIPTION OF THE DRAWINGS

FIG. 1 illustrates a block diagram of a mobile beverage dispensing unit, in accordance with an embodiment of the invention.

FIG. 2a illustrates a mobile beverage dispensing unit including a replaceable mixing module and two replaceable syrup modules.

FIG. 2b illustrates of a mobile beverage dispensing unit including a replaceable mixing module and three replaceable syrup modules.

FIG. 2c illustrates a mobile beverage dispensing unit including a replaceable mixing module and three replaceable syrup modules.

FIG. 3 illustrates a mobile beverage dispensing unit including two replaceable syrup modules with their bag-in-box containers removed.

FIG. 4 illustrates a mobile beverage dispensing unit having a replaceable mixing module and two replaceable syrup modules.

FIG. 5 illustrates a method of providing a fountain beverage, according to an aspect of the invention.

### DETAILED DESCRIPTION OF THE INVENTION

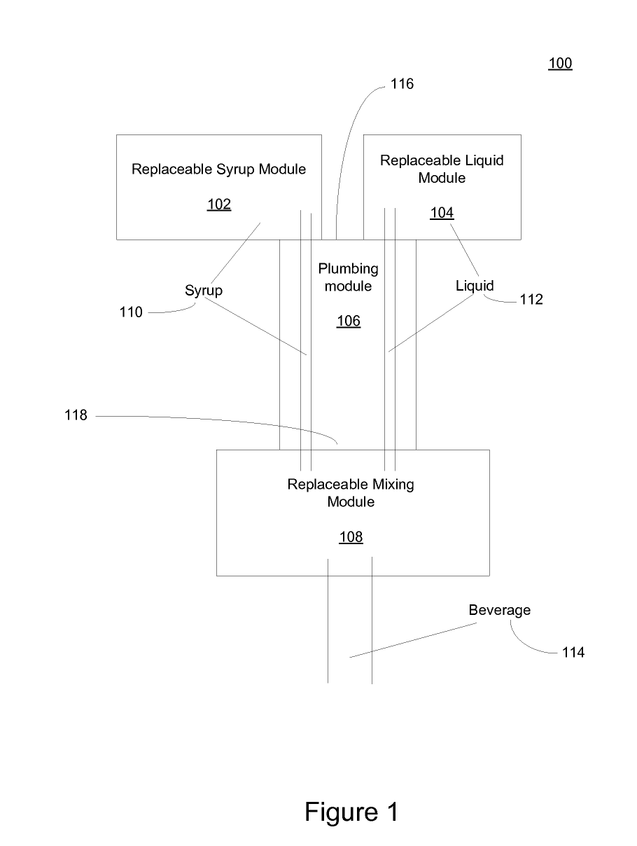

FIG. 1 illustrates a mobile beverage dispensing unit 100 in accordance with an embodiment of the invention. The mobile beverage dispensing unit 100 comprises modular components that allow for rapid replacement of the components. A replaceable syrup module 102 contains syrup 110 that may be mixed with liquid 112 to create a beverage 114. The replaceable syrup module 102 may include a conventional bag-in-box container. A bag-in-box container may contain flavored syrup 110 that may be mixed with water or another liquid 112 to form a beverage 114. The water or other liquid 112 may be non-carbonated or carbonated and thus, may create a non-carbonated or carbonated beverage 114. A pump may be contained within the replaceable syrup module 102 and may be positioned to cause syrup 110 to be pumped through the plumbing module 106 and into the replaceable mixing module 108. The plumbing module 106 may include a tube through which the syrup 110 may flow and the tube may be impermeable to liquid 112. A first end of a first portion 116 of the plumbing module 106 may be connected to both the replaceable syrup module 102 and the replaceable liquid module 104. A second end of the first portion 118 of the plumbing module 106 may be connected to the replaceable mixing module 108. One skilled in the art will recognize that the plumbing module 106 may be connected to a plurality of modules of the mobile beverage dispensing unit 100, as needed by the user. The plumbing module 106 may contain the liquid 112 as the liquid 112 is being released from the replaceable liquid module 104 and being caused to flow into the replaceable mixing module 108.

The replaceable syrup module 102, the replaceable liquid module 104, the replaceable mixing module 108, and the plumbing module 106 may be attached to one another to form a modular mobile beverage dispensing unit and may be positioned in the same room to operate with low noise.

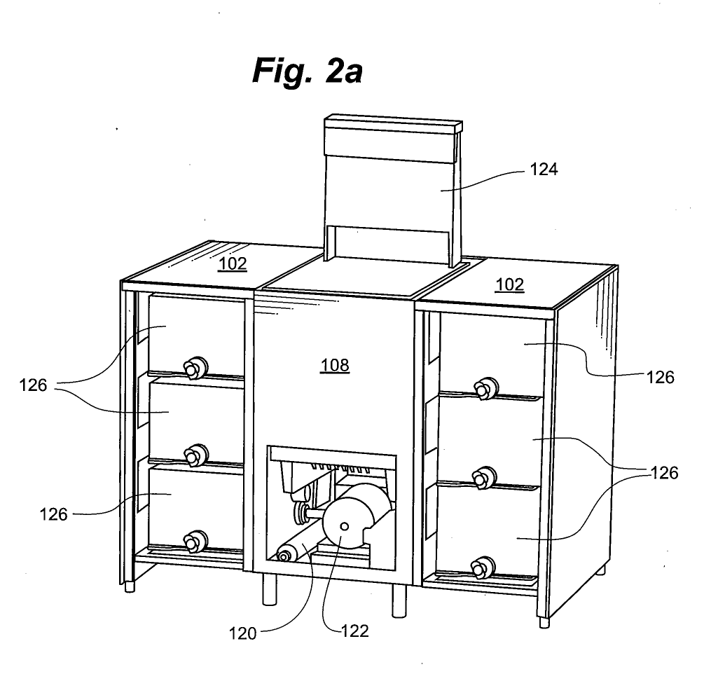

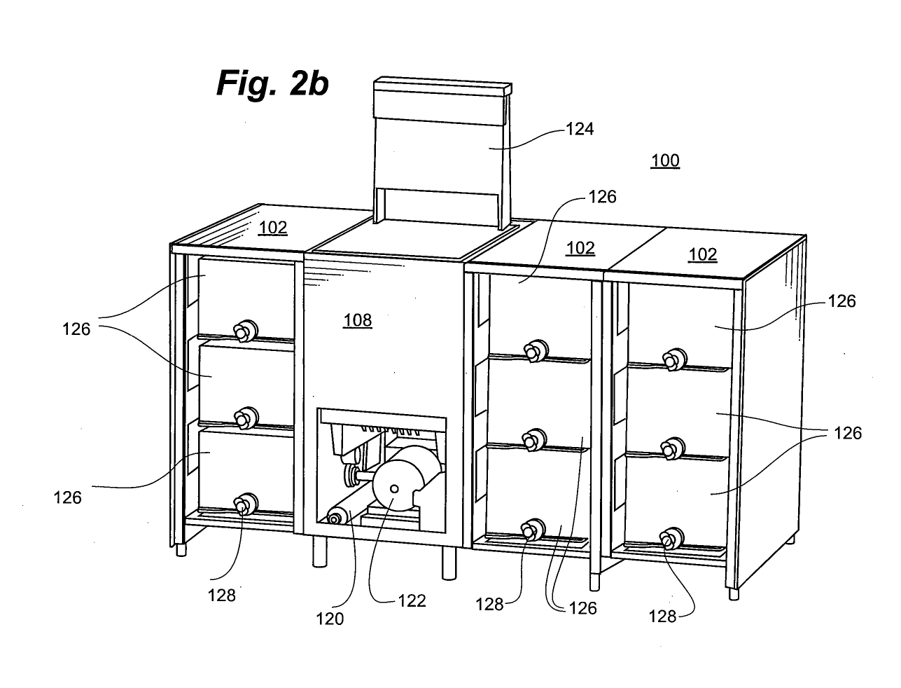

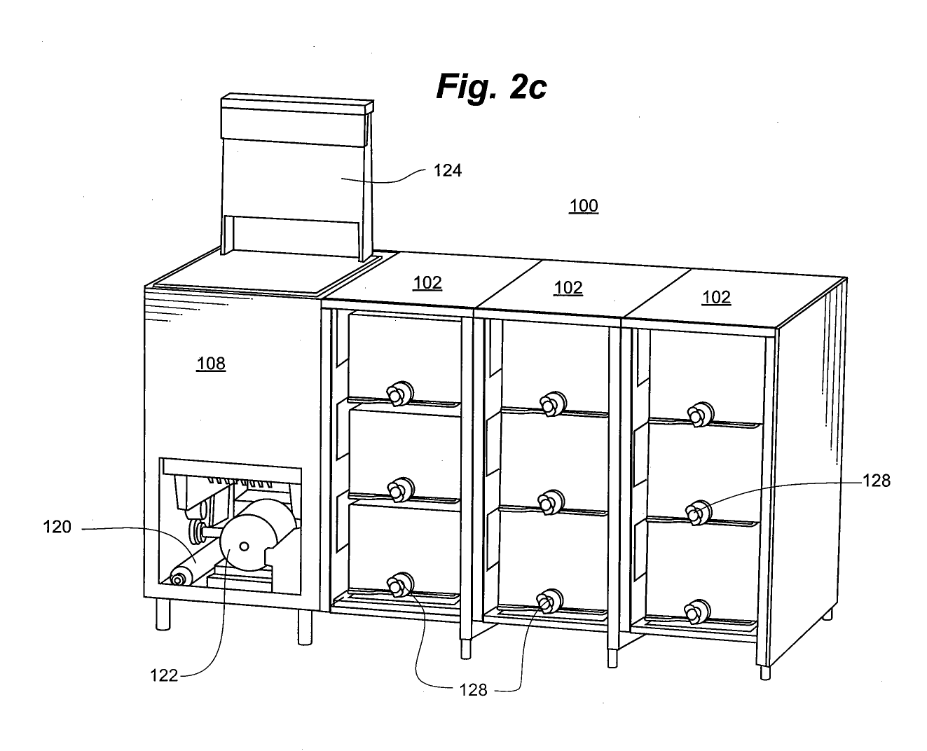

A low noise pump 120, such as an electrical pump, may be included in the mobile beverage dispensing unit 100 to pump the syrup 110 out of the replaceable syrup module 102, as illustrated in FIGS. 2a-2c. The electrical pump 120 may be positioned adjacent to the replaceable syrup module 102. The mobile beverage unit 100 may also include a motor 122, as shown in FIGS. 2a-2c, that may be connected to the electrical pump 120 and may supply the electrical pump 120 with mechanical or electrical energy to cause the syrup 110 that is contained within the replaceable syrup module 102 to flow from the replaceable syrup module 102 into the replaceable mixing module 108. A pan (not shown) may be positioned in the mobile beverage dispensing unit 100 so that it may collect syrup 110 and liquid 112 that may leak during operation.

A replaceable liquid module 104 is included in the mobile beverage dispensing unit 100 for dispensing a liquid 112. The replaceable liquid module 104 may include a water tank that contains water or may be connected to another water source (not shown). The water source may be detachable from the mobile beverage dispensing unit 100 or it may be included in the replaceable liquid module 104. The replaceable liquid module 104 may cause non-carbonated water or carbonated water to flow into the replaceable mixing module 108 so that a non-carbonated beverage or a carbonated beverage, respectively, may be formed when the liquid 112 is mixed with the syrup 110.

The mobile beverage dispensing unit 100 may include a second replaceable syrup module for containing a second syrup. The replaceable mixing module 108 may cause the second syrup to be mixed with the liquid 112 to create a second beverage. The second syrup may have a flavor that is different from the flavor of the other syrup. A mobile beverage dispensing unit 100 having at least two different flavors of syrup is capable of creating a variety of different flavored beverages.

The replaceable mixing module 108 may include a carbonator (not shown) that is capable of carbonating water or a beverage before it is dispensed. The carbonator may carbonate the water in any desired manner that may be known or practiced by one skilled in the art. Non-carbonated water may be dispensed from the replaceable liquid module 104 and may be mixed with syrup 110 to form a beverage 114 that then flows into the carbonator where the carbonator carbonates the beverage 114. Non-carbonated water may also be caused to flow through the carbonator to create a carbonated liquid before it is mixed with syrup 110 to form a carbonated beverage. The carbonator may be positioned adjacent to the mobile beverage dispensing unit 100 or in any convenient configuration.

A plumbing module 106 connects the replaceable syrup module 102 and the replaceable liquid module 104 to the replaceable mixing module 108. The plumbing module 106 may also connect the replaceable mixing module 108 to a replaceable dispensing module 124. The replaceable dispensing module 124 may cause the beverage 114 to be dispensed at the user's command. The replaceable dispensing module 124 may include a beverage gun and/or a plurality of dispensing nozzles (not shown). The beverage gun and dispensing nozzles control the flow of the beverage 114 from the replaceable dispensing module 124. A user may access the beverage 114 by causing the beverage gun or dispensing nozzle to dispense a desired amount of beverage 114. One skilled in the art will appreciate that any desirable dispensing mechanism may be used to cause the beverage 114 to be dispensed from the mobile beverage dispensing unit 100.

FIGS. 2a-2c illustrate a mobile beverage dispensing unit 100. The mobile beverage dispensing unit 100 is modular in nature, and the modules may be connected to each other in any desirable manner. The mobile beverage dispensing unit 100 comprises a replaceable syrup module 102, a replaceable liquid module 104, a replaceable mixing module 108, and a plumbing module 106, as described above. FIG. 2a illustrates a mobile beverage dispensing unit 100 having two replaceable syrup modules 102, wherein each one of the replaceable syrup modules 102 is positioned on either side of the replaceable mixing module 108. Each of the replaceable syrup modules 102 may contain a plurality of bag-in-box containers 126, wherein a flavored syrup is contained in each bag-in-box container 126. The bag-in-box containers 126 may be positioned in a vertical stack as shown in FIGS. 2a-2c. Oftentimes, each bag-in-box container 126 will include an outlet 128 on one side. Some embodiments arrange all of the bag-in-box containers 126 so that all of the outlets 128 of each bag-in-box container 126 face in the same direction. This configuration provides the user with easy access to replace or service each of the bag-in-box containers 126 from the same side of the mobile beverage dispensing unit 100.

The mobile beverage dispensing unit 100 may also include a replaceable dispensing module 124, as described above, that is capable of controlling the beverage 114 as it is dispensed. The replaceable dispensing module 124 and the replaceable mixing module 108 may be attached to each other and may be positioned adjacent to one another. The two replaceable syrup modules 102 shown in FIG. 2a are positioned on either side of the replaceable mixing module 108. FIGS. 2b and 2c each show a mobile beverage dispensing unit 100 having a replaceable mixing module 108 that is positioned adjacent to a replaceable dispensing module 124 and having three replaceable syrup modules 102. In FIG. 2b, for example, two replaceable syrup modules 102 are positioned on one side of the replaceable mixing module 108 and a third replaceable syrup module 102 is positioned on the opposite side of the replaceable mixing module 108. FIG. 2c illustrates another embodiment having three replaceable syrup modules 102, wherein all three replaceable syrup modules 102 are positioned on the same side of the replaceable mixing module 108. One skilled in the art will appreciate that the replaceable syrup modules 102 and the replaceable mixing module 108 may be configured in any desirable arrangement.

The mobile beverage dispensing unit 100 may include a motor 122 and a pump 120. The motor 122 may convert electricity that is provided by a power source (not shown) to mechanical energy to operate the pump 120. The pump 120 may cause syrup 110 to be released from the replaceable syrup modules 102 into the replaceable mixing module 108 and may also cause water or liquid 112 to be released from the replaceable liquid module 104 into the replaceable mixing module 108. The pump 120 may be an electrical pump. Some electrical pumps produce less noise than non-electrical pumps when they are in operation.

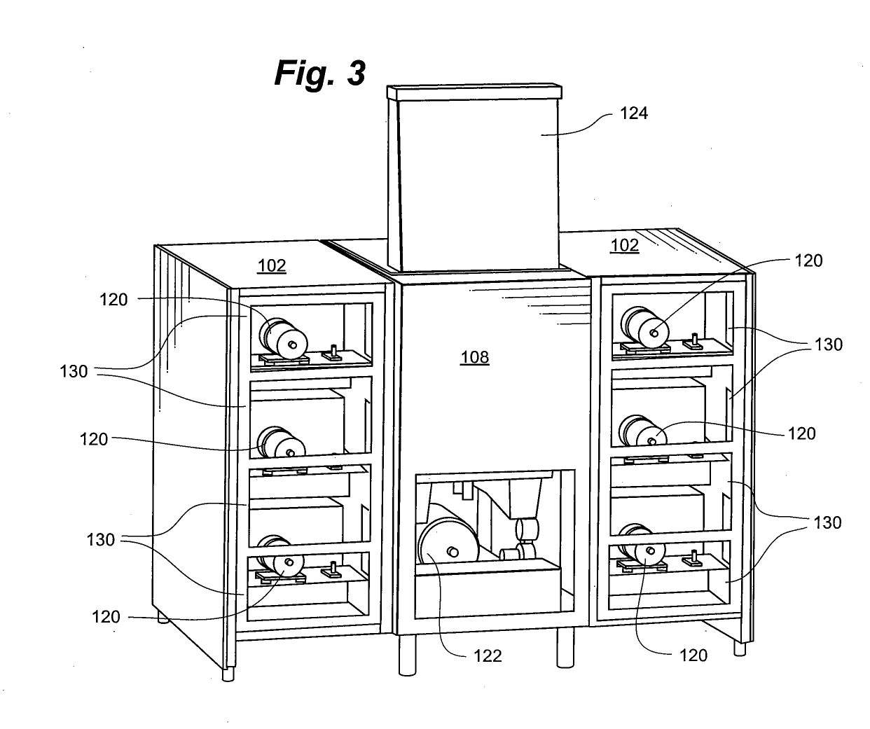

In FIG. 3, the mobile beverage dispensing unit 100 is shown with the bag-in-box containers 126 removed from the replaceable syrup module 102. Each replaceable syrup module 102 shown in FIG. 3 has four bag-in-box containers 126 and a motor 122 that is connected to each bag-in-box container 126. Syrup 110 that is contained within each bag-in-box container 126 is pumped from the bag-in-box container 126 to the replaceable mixing module 108. FIG. 3 illustrates the replaceable syrup module 102 that may have a receptacle 130 for receiving a bag-in-box container 126. Once inserted into the receptacle 130, each bag-in-box container 126 may be connected to a motor 122 and a pump 120.

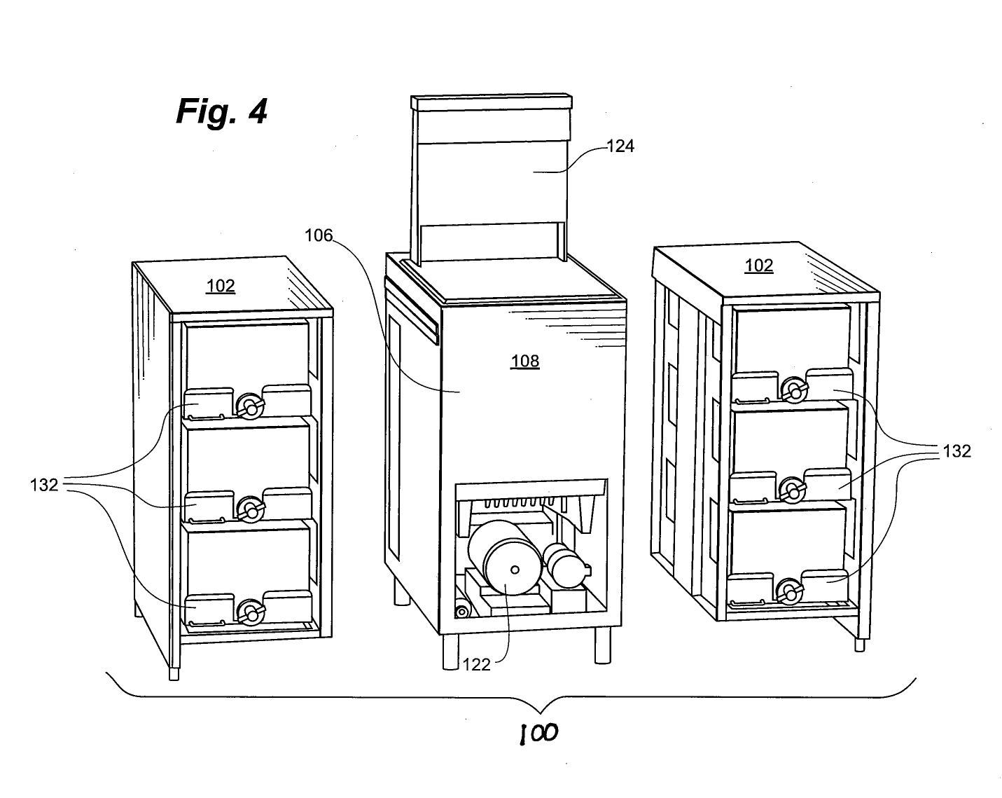

FIG. 4 illustrates a mobile beverage dispensing unit 100 having two replaceable syrup modules 102, a replaceable mixing module 108, and a replaceable dispensing module 124. The two replaceable syrup modules 102 and the replaceable mixing module 108 are detachable from one another. In FIG. 4, the replaceable syrup modules 102 and the replaceable mixing module 108 are shown separated from each other to clearly illustrate the modular and detachable structure of the mobile beverage dispensing unit 100. A plurality of bag-in-box containers 126 may be inserted within the replaceable syrup module 102, as described above, and may each be supported by a drawer 132, as illustrated in FIG. 4. The drawer 132 may be made of stainless steel and may be configured to collect syrup 110 that leaks from the bag-in-box container 126. The drawer 132 may also provide additional structural support for the weight of the bag-in-box container 126.

In another embodiment of the invention, a mobile beverage dispensing system 100 may comprise a bag-in-box container 126 for containing syrup 110, an electrical pump 120 that may be connected to the bag-in-box container 126 and that is capable of causing the syrup 110 to be dispensed from the bag-in-box container 126 into a syrup portion of a plumbing system 106, and a water source (not shown) that is capable of dispensing water 112 into a water portion of the plumbing system 106. The electrical pump 120 may be positioned adjacent to the bag-in-box container 126. A replaceable mixing unit 108 may be connected to the syrup portion of the plumbing system 106 and may be configured to receive the syrup 110. The mixing unit 108 may also be connected to the water portion of the plumbing system 106 and may be configured to receive the water 112. The mixing unit 108 may be capable of mixing the water 112 and the syrup 110 to create a beverage 114. A dispensing unit 124 is capable of dispensing the beverage 114. The bag-in-box container 126, the electrical pump 120, the plumbing system 106, the water source, the mixing unit 108, and the dispensing unit 124 form a modular mobile beverage dispensing system and may be configured to be positioned within the same room to operate with low noise.

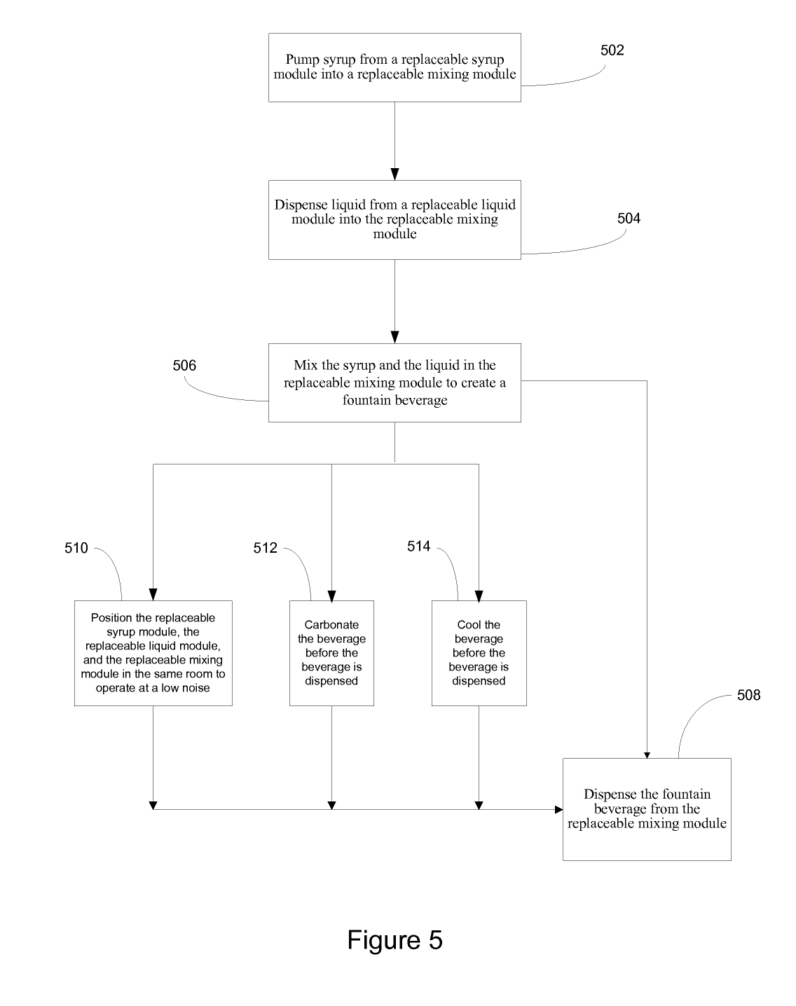

FIG. 5 illustrates a method for providing a fountain beverage, in accordance with another aspect of the invention. A method provides a fountain beverage 114, wherein syrup is pumped from a replaceable syrup module into a replaceable mixing module 502 and liquid is dispensed from a replaceable liquid module into the replaceable mixing module 504. The syrup and the liquid are then mixed in a replaceable mixing module to create a fountain beverage 506. The replaceable syrup module, the replaceable liquid module, and the replaceable mixing module may be positioned adjacent to each other. The replaceable syrup module, the replaceable liquid module, and the replaceable mixing module may all be placed within the same room to operate at a low noise 510. The fountain beverage may also be carbonated before it is dispensed 512. After the fountain beverage is created, the fountain beverage may be cooled before being dispensed 514. One skilled in the art will appreciate that the fountain beverage may be carbonated and cooled in any manner that may be known or practiced in the art. One skilled in the art will also recognize that any one of steps 510, 512, and 514 or any combination of steps 510, 512, and 514 (combinations not shown) may be included in the method of providing a fountain beverage.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

I/we claim:

1. A mobile beverage dispensing unit, comprising:
a replaceable syrup module for containing a syrup;
a replaceable liquid module for dispensing a liquid;
a replaceable mixing module that may cause the syrup and the liquid to be mixed to form a beverage; and
a plumbing module, wherein a first end of a first portion of the plumbing module may be connected to the replaceable syrup module and the replaceable liquid module and a second end of a first portion of the plumbing module may be connected to the replaceable mixing module;
wherein the replaceable syrup module, the replaceable liquid module, the replaceable mixing module, and the plumbing module form a modular mobile beverage dispensing unit.

2. The mobile beverage dispensing unit of claim 1, further comprising an electrical pump.

3. The mobile beverage dispensing unit of claim 1, wherein the replaceable syrup module includes a bag-in-box container.

4. The mobile beverage dispensing unit of claim 3, further comprising a drawer that is capable of supporting the bag-in-box container, wherein a portion of the drawer is made at least partially of stainless steel.

5. The mobile beverage dispensing unit of claim 1, wherein the replaceable syrup module, the replaceable liquid module, the replaceable mixing module, and the plumbing module are configured to be positioned within the same room and are configured to operate with low noise.

6. The mobile beverage dispensing unit of claim 1, wherein the electrical pump is positioned adjacent to the replaceable syrup module.

7. The mobile beverage dispensing unit of claim 1, wherein the beverage is carbonated.

8. The mobile beverage dispensing unit of claim 1, wherein a pan may be positioned to collect syrup and liquid that may leak from the mobile beverage dispensing unit.

9. The mobile beverage dispensing unit of claim 1, further comprising a second replaceable syrup module for containing a second syrup, wherein the replaceable mixing module may cause the second syrup to be mixed with the liquid to create a second beverage.

10. A mobile beverage dispensing system, comprising:
a bag-in-box container for containing syrup;
an electrical pump that is connected to the bag-in-box container and is capable of causing syrup to be dispensed from the bag-in-box container into a syrup portion of a plumbing system;
a water source capable of dispensing water into a water portion of the plumbing system;
a mixing unit that is connected to the syrup portion of the plumbing system and configured to receive the syrup, and wherein the mixing unit is also connected to the water portion of the plumbing system and configured to receive the water, wherein the mixing unit is capable of mixing the water and the syrup to create a beverage; and
a dispensing unit that is capable of dispensing the beverage;
wherein the bag-in-box container, the electrical pump, the plumbing system, the water source, the mixing unit, and the dispensing unit form a modular mobile beverage dispensing system.

11. The mobile beverage dispensing system of claim 10, wherein the bag-in-box container, the electrical pump, the plumbing system, the water source, the mixing unit, and the dispensing unit are configured to be positioned within the same room to operate with low noise.

12. The mobile beverage dispensing system of claim 10, wherein the electrical pump is positioned adjacent to the bag-in-box container.

13. The mobile beverage dispensing system of claim 10, wherein the beverage is carbonated.

14. The mobile beverage dispensing system of claim 10, wherein a pan may be positioned to collect syrup and liquid that may leak from the mobile beverage dispensing system.

15. The mobile beverage dispensing system of claim 10, further comprising a drawer that may support the bag-in-box container, wherein a portion of the drawer contains stainless steel.

16. The mobile beverage dispensing system of claim 10, further comprising a second bag-in-box container for containing a second syrup, wherein the mixing unit may cause the second syrup to be mixed with the water to create a second beverage.

17. A method of providing a fountain beverage, comprising:
pumping syrup from a replaceable syrup module into a replaceable mixing module;
dispensing liquid from a replaceable liquid module into the replaceable mixing module;
mixing the syrup and the liquid in the replaceable mixing module to create a fountain beverage, wherein the replaceable syrup module, the replaceable liquid module, and the replaceable mixing module are positioned adjacent to each other; and
dispensing the fountain beverage from the replaceable mixing module.

18. The method of providing a fountain beverage of claim 17, further comprising:
positioning the replaceable syrup module, the replaceable liquid module, and the replaceable mixing module in the same room to operate at a low noise.

19. The method of providing a fountain beverage of claim 17, further comprising:
carbonating the beverage before the beverage is dispensed.

20. The method of providing a fountain beverage of claim 17, further comprising:
cooling the beverage before the beverage is dispensed.
